(19) United States
(12) Patent Application Publication
(10) Pub. No.: US 2011/0196775 A1
(43) Pub. Date: Aug. 11, 2011

(54) Systems, Methods, and Media for Controlling the Exposure of Orders to Trading Platforms

(76) Inventors: Jeffrey Gavin, Holbrook, MA (US); Robert Keller, West Newton, MA (US); Benjamin Jewell, Boston, MA (US); Matthew Johnston, Weymouth, MA (US)

(21) Appl. No.: 12/983,697

(22) Filed: Jan. 3, 2011

Related U.S. Application Data
(60) Provisional application No. 61/291,858, filed on Jan. 1, 2010.

(51) Int. Cl. G06Q 40/00

(52) U.S. Cl. 705/37

(57) ABSTRACT

Systems, methods, and media for controlling the exposure of orders to trading platforms are provided. In accordance with some embodiments, systems for controlling the exposure of orders to trading platforms are provided, the systems comprising: at least one hardware processor that: receives information for at least one order to trade a security; and for each of a plurality of trading platforms, determines how the at least one order is to be exposed to trading platform based on at least one of a default exposure setting for all orders for the trading platform, at least one filter for the trading platform, and an exposure status setting for the trading platform and the at least one order, and provides information for the at least one order to the trading platform.

### CROSS REFERENCE TO RELATED APPLICATION

This application is claims the benefit of U.S. Provisional Patent Application No. 61/291,858, filed Jan. 1, 2010, which is hereby incorporated by reference herein in its entirety.

### TECHNICAL FIELD

The disclosed subject matter relates to systems, methods, and media for controlling the exposure of orders to trading platforms.

### BACKGROUND

While many advancements have been made in recent years in connection with the management of orders for trading securities, order management continues to be a time consuming and largely manual task. Traders interacting with multiple trading platforms are commonly required to use multiple user interfaces (one for each such trading platform) to interact with the platform and control how their orders are exposed to those platforms. Prior systems fail to provide a mechanism for controlling the exposure of open orders at a multiple trading platforms.

### SUMMARY

Systems, methods, and media for controlling the exposure of orders to trading platforms are provided. In accordance with some embodiments, systems for controlling the exposure of orders to trading platforms are provided, the systems comprising: at least one hardware processor that: receives information for at least one order to trade a security; and for each of a plurality of trading platforms, determines how the at least one order is to be exposed to trading platform based on at least one of a default exposure setting for all orders for the trading platform, at least one filter for the trading platform, and an exposure status setting for the trading platform and the at least one order, and provides information for the at least one order to the trading platform.

In accordance with some embodiments, methods for controlling the exposure of orders to trading platforms are provided, the methods comprising: receiving information for at least one order to trade a security; and for each of a plurality of trading platforms, determining how the at least one order is to be exposed to trading platform based on at least one of a default exposure setting for all orders for the trading platform, at least one filter for the trading platform, and an exposure status setting for the trading platform and the at least one order, and providing information for the at least one order to the trading platform.

In accordance with some embodiments, computer-readable media containing computer-executable instructions that, when executed by a processor, cause the processor to perform methods for controlling the exposure of orders to trading platforms, the methods comprising: receiving information for at least one order to trade a security; and for each of a plurality of trading platforms, determining how the at least one order is to be exposed to trading platform based on at least one of a default exposure setting for all orders for the trading platform, at least one filter for the trading platform, and an exposure status setting for the trading platform and the at least one order, and providing information for the at least one order to the trading platform.

### BRIEF DESCRIPTION OF THE DRAWINGS

FIG. 1 is a diagram of a trading blotter interface that can be used in accordance with some embodiments.

FIG. 2 is a diagram of a properties interface that can be used in accordance with some embodiments.

FIG. 3 is a diagram of a filter adding interface that can be used in accordance with some embodiments.

FIG. 4 is a diagram of a grid display settings interface that can be used in accordance with some embodiments.

FIG. 5 is a diagram of a trade negotiation interface that can be used in accordance with some embodiments.

FIG. 6 is a diagram of a process for exposing orders to a plurality of trading platforms that can be used in accordance with some embodiments.

FIG. 7 is a diagram of a system that can be used in accordance with some embodiments.

### DETAILED DESCRIPTION

Systems, methods, and media for controlling the exposure of orders to trading platforms are provided.

In accordance with some embodiments, mechanisms are provided for controlling how orders are exposed to a plurality of trading platforms. In some embodiments, order information from an order management system is copied into a trading blotter. Within the trading blotter, rows are displayed with information that corresponds to open orders in the order management system. Using the blotter, a trader can control, for each order, whether the order is to be exposed to each of a plurality of platforms. Additionally, in some embodiments, the trader can specify filters that determine conditionally whether an order is to be exposed to a trading platform. In conjunction with one or more contra-orders identified by the trading platforms, trades can then be executed. This execution can include, in some embodiments, trader activity through a negotiation interface with a contra-trader.

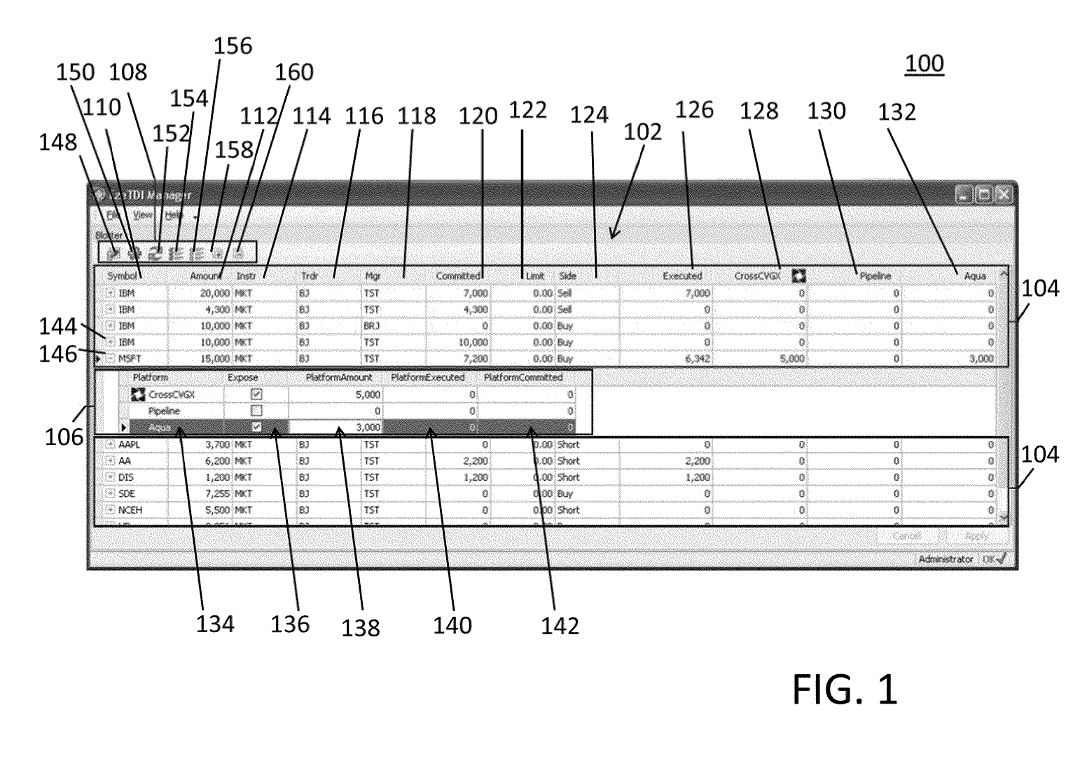

Turning to FIG. 1, an example of an interface 100 for controlling orders in accordance with some embodiments is illustrated. As shown, interface 100 includes a blotter 102 with trade-level rows 104, platform-level rows 106, and control icons 108. Trade-level rows 104 can be rows of trade-level information for orders in the blotter. Each platform-level row 106 can be a row of platform-level information for an order of a corresponding trade-level row 104 in the blotter. These platform level rows 106 can be displayed or hidden for an order of the corresponding trade-level row 104 by clicking on the plus (“+”) icon 144 or minus (“−”) icon 146, respectively, in the trade-level row 104. Control icons 108 can be any suitable icons and/or other control interfaces for controlling orders in the blotter.

More particularly, a trade-level row 104 can include, for each order represented by the row, indicators of a symbol in column 110, a total amount or size of the order in column 112, an order type in column 114, a trader in column 116, a manager in column 118, an amount committed in column 120, a limit price in column 122, a side of the order in column 124, an amount executed in column 126, and amounts currently exposed to a plurality of platforms in columns 128, 130, and/or 132. The symbol indicated in column 110 can be any suitable symbol for indicating a security for a trade. The total amount indicated in column 112 can be the total amount of the order for the security and can be in any suitable units. The order type indicated in column 114 can indicate whether the order is a market (MKT) order, a limit (LMT) order, and/or any suitable order type. The trader indicated in column 116 can be any trader associated with the order, and can be indicated by initials of a trader, for example. The manager indicated in column 118 can be any manager associated with the order; and can be indicated by initials of a manager, for example. The amount committed indicated in column 120 can be the total amount of the order that has been committed and can be in any suitable units. This can include broker commitment amounts, platform amounts committed through the blotter, and any other suitable commitment amounts. The limit price indicated in column 122 can be a limit price for limit order-type orders when applicable. The side indicated in column 124 can indicate whether the order is a buy order, a sell order, short order, a cover order, or any other suitable order side. The amount executed indicated in column 126 can be the total amount of the order that has been executed. And, the amounts currently exposed to a plurality of platforms indicated in columns 128, 130, and/or 132 can be the amount of the order that is exposed to each platform in the corresponding column.

As also illustrated in FIG. 1, in some embodiments, columns 128, 130, and/or 132 can have headers that indicate the name, an icon, a logo, and/or any other suitable indicator of a trading platform corresponding to the column.

In some embodiments, a trade ID indicator (not shown) can additionally or alternatively be indicated for each order in each trade-level row 104. This trade ID can indicate an identifier that can be used to track a trade of the order.

Each platform-level row 106 can include, for a platform represented by the row 106 and for an order in a corresponding row 104, indicators of the platform in column 134, the exposure status of the platform (i.e., whether the order is exposed to the platform) in column 136, the maximum platform amount in column 138, the amount executed on the platform in column 140, and the amount committed to the platform in column 142. The platform can be indicated in column 134 using the name, an icon, a logo, and/or any other suitable indicator of a trading platform corresponding to the row 106. The exposure status indicated in column 136 can indicate whether a trading platform corresponding to the row 106 is exposed to an order (i.e., is able to receive block orders for possible execution at the platform) indicated in a corresponding row 104, and can be set or cleared by a user clicking on the check box in column 136. The exposure status can also be changed for all platform rows 106 of an order row 104 by right-clicking on the order row 104 and selecting “select all” or “deselect all” from a context menu. Similarly, the exposure status can also be changed for all orders for a platform indicated in a column 128, 130, or 132 by right-clicking on the corresponding column header and selecting “select all” or “deselect all” from a context menu. The maximum platform amount indicated in column 138 can indicate the maximum amount of the order in the corresponding row 104 that is exposed to the platform in the row 106, can be in any suitable units, and can be subject to the exposure status and/or any applicable filters (discussed below). The platform amount executed indicated in column 140 can indicate the amount of the order in the corresponding row 104 executed in the platform indicated in the row 106, and can be in any suitable units. The platform amount committed indicated in column 142 can indicate the amount of the order in the corresponding row 104 committed to the platform in the row 106, and can be in any suitable units.

Control icons 108 can include controls for adding and removing columns in blotter 102 (e.g., using icon 148), configuring properties of the blotter such as preferences, filters, and grid settings (e.g., using icon 150), manually refreshing data in the blotter (e.g., using icon 152), selecting the exposure status check box for all platform-level rows 106 in the blotter (e.g., using icon 154), clearing the exposure status check box for all platform-level rows 106 in the blotter (e.g., using icon 156), displaying the platform-level rows 106 for each order in the blotter (e.g., using icon 158), hiding the platform-level rows for each order in the blotter (e.g., using icon 160), and/or for any other suitable function.

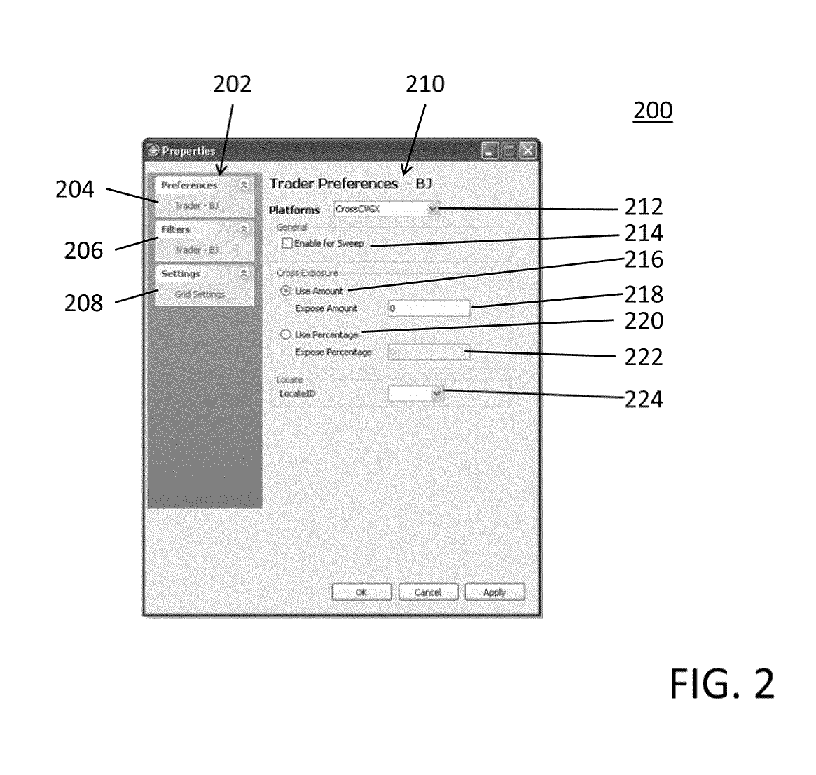

Turning to FIG. 2, a user interface 200 for configuring properties of the blotter in accordance with some embodiments is shown. This interface can be presented in response to a user clicking-on icon 150 of FIG. 1, for example. As illustrated, interface 200 can include a menu 202 having a preferences option 204, a filters option 206, and a settings option 208. Any other suitable options can additionally or alternatively be included in menu 202.

When a preferences option 204 is selected, a trader preferences control interface 210 can be presented in interface 200. Using interface 210, a trader can configure, for each platform, whether new orders will be exposed by default to the platform, the amount of exposure, and a locate ID for the orders. For example, a trader can select a specific platform for which these settings are to be configured using menu 212. This menu can list the available platforms. After a platform has been selected from menu 212, interface 210 can display the current settings for the platform in fields 214, 216, 218, 220, 222, and 224. Using the check box in field 214, the trader can select whether or not new orders are to be automatically exposed by default to the selected platform via the blotter. The trader can also select the amount of exposure for orders to the selected platform using the radio buttons in fields 216 and 220 and the boxes in fields 218 and 222 for those instances in which the orders are to be exposed, whether by default, via a filter (discussed below), or by an exposure status setting in a platform-level row 106, to the platform. For example, by selecting the radio button in field 216, the trader can select that the order is to be exposed by an absolute amount entered into the box in field 218. As another example, by selecting the radio button in field 220, the trader can select that the order is to be exposed by a relative amount entered into the box in field 222. Using the menu in field 224, the trader can select a locate ID to be associated with short orders to the selected platform. Any suitable identifier for the locate ID can be used. For example, the locate ID can specify from whom the trader obtained borrowed stock for a short order.

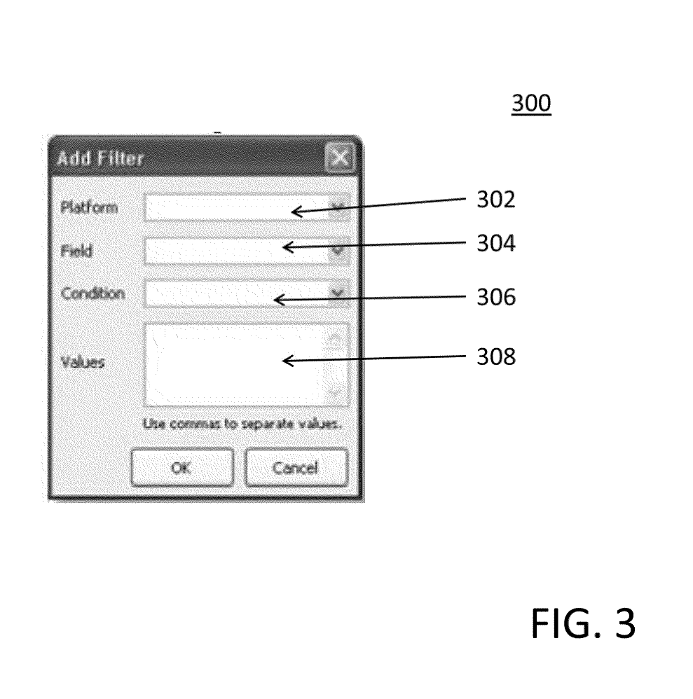

Turning to FIG. 3, a user interface 300 that can be presented when a user selects option 206 from menu 202 of FIG. 2 is illustrated. User interface 300 can be used to add or configure filters to override default exposure status settings. For example, filters can be inclusion filters or exclusion filters based on whether the blotter has been configured to automatically expose new orders by default to a corresponding platform (e.g., when configured to not expose new orders by default, the filters can be inclusion filters, and when configure to expose new orders by default, the filters can be exclusion filters). As shown, interface 300 can include a platform menu 302 from which the trader can select a platform to which a filter is to apply. Interface 300 can also include a field menu 304 from which the trader can select a field of the order to be evaluated by the filter. Any suitable field can be used/selected. For example, the field can be security type. Interface 300 can also include a values list 308 indicating what value(s) of the selected field will satisfy the filter. Any suitable one or more values can be listed in any suitable manner (e.g., separated by commas), and more than one value can be logically combined in any suitable manner (e.g., such as by a logical AND, a logical OR, etc.), in some embodiments. Interface 300 can further include a condition menu 306 from which the trader can select what condition is to occur if the filter is satisfied. For example, the selected condition can indicate that the order is to be exposed to the selected platform if the filter is satisfied, or that the order is not to be exposed to the selected platform is the filter is satisfied.

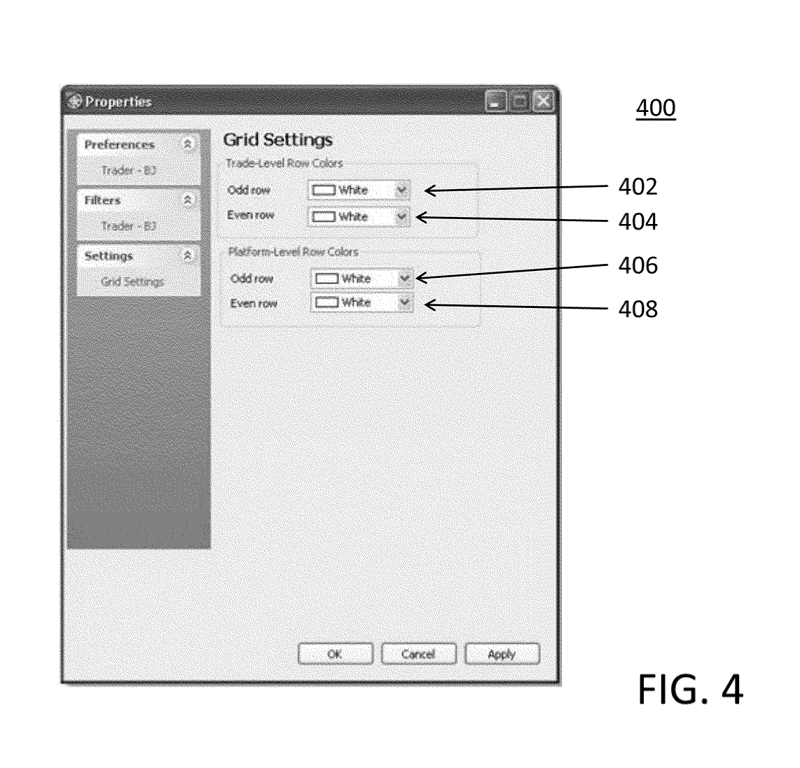

FIG. 4 illustrates an example of a user interface 400 that can be used to configure how rows 104 and 106 are displayed in the blotter in response to a user selecting option 208 of FIG. 2. For example, using menu 402, a user can configure a background color for odd trade-level rows 104, using menu 404, a user can configure a background color for even trade-level rows 104, using menu 406, a user can configure a background, color for odd platform-level rows 106, and using menu 408, a user can configure a background color for even platform-level rows 106. Additionally or alternatively to setting background colors, any other suitable display setting can be configured, such as font, size, foreground color, italics, bold, etc.

In some embodiments, administrators can control one, some, or all of the settings and configurable items described herein for one, some, or all traders. For example, an administrator can control the properties configurable via interface 200, such as preferences, filters, and/or grid settings.

After a potential match is found for a block order exposed to a platform by the blotter, a negotiation window can be presented to enable a trader to negotiate the terms of the trade. For example, the trader can specify the price at which the trader wants to execute an order. This negotiation window can also be used to work a trade by adding additional volume to the trade.

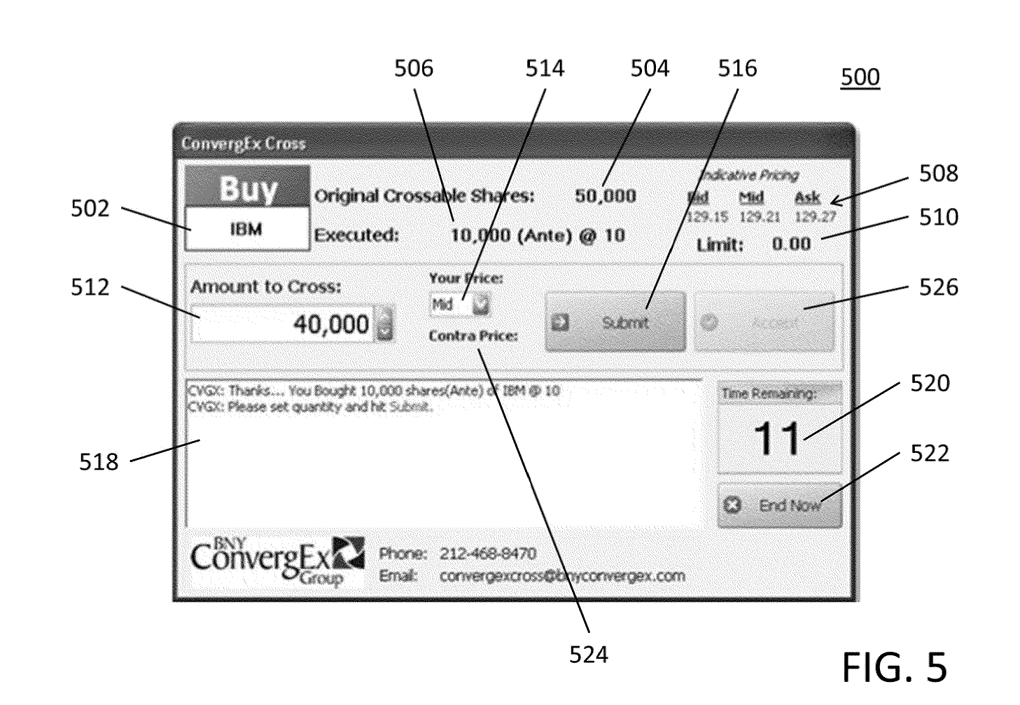

FIG. 5 illustrates an example of a user interface 500 for negotiating a trade in a security in accordance with some embodiments. As illustrated, after a match between a block order exposed to a platform and a contra-order at the platform are identified, a negotiation interface can be presented. This interface can present information about the trade being executed, such as the security 502, the maximum amount exposed to the platform 504, any amount already executed at the platform 506, current market pricing on the security 508, and a limit price for the order 510. A trader using this interface can then select an amount to be executed using field 512, select a price basis for the trade using menu 514, and submit the order using button 516. Comments can be presented and/or entered in field 518 to allow the trader to negotiate with a contra party. A time remaining to negotiate a trade can be presented in field 520, and an end-now button 522 can be presented to enable the trader to terminate the negotiation.

Base on the actions of a contra party, a contra price for the security and size can be presented in field 524. If this contra price is acceptable to the trader, the trader can accept the order using accept button 526.

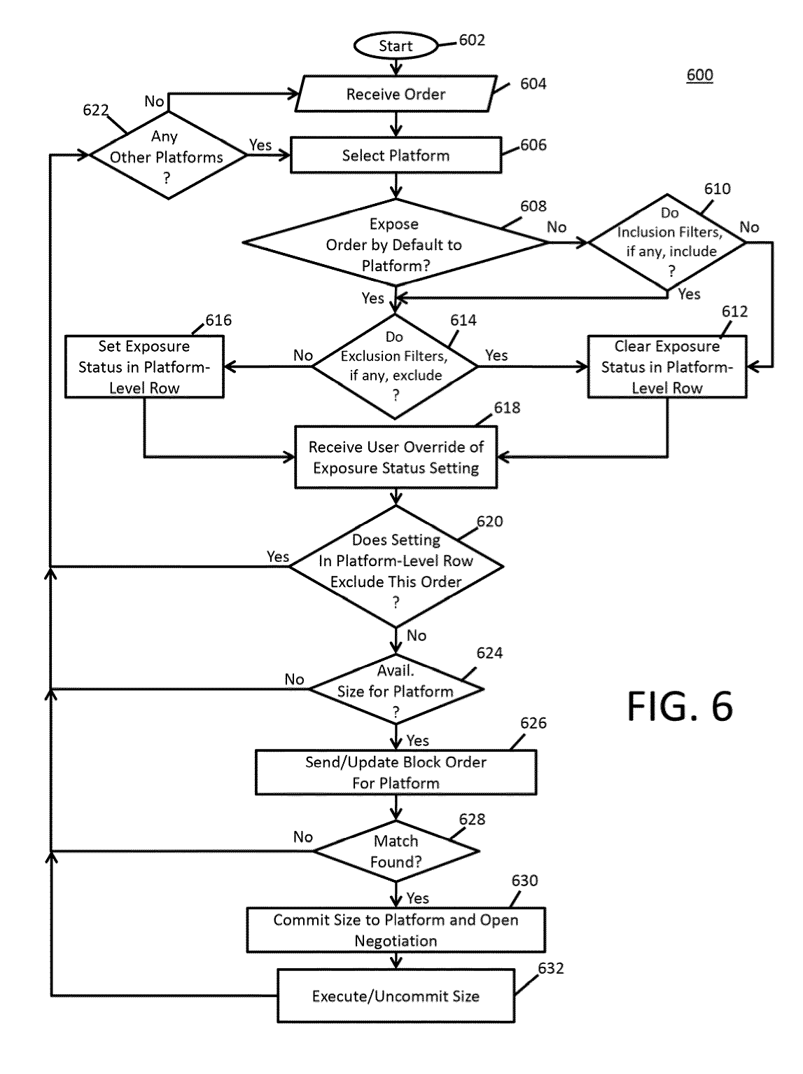

Turning to FIG. 6, a flow chart of a process 600 that can be used to control orders in accordance with some embodiments is illustrated. As shown, after process 600 begins at 602, the process can receive an order at 604. This order can be received using any suitable process, such as by receiving a new order from a scrape of an order management system, such as by receiving an existing order from a list of orders in blotter 102 of FIG. 1, etc. Next, at 606, the process can select a platform to evaluate the order against. This platform can be selected in any suitable manner, such as by selecting the first platform in a list of available platforms, selecting the next platform in a list of available platforms, etc. At 608, the process can then determine whether the order is to be exposed to the platform by default. This determination can be made based on an exposure setting 214 for the platform configured using a configuration setting in a user interface such as interface 200 of FIG. 2. If the order is determined to not be exposed by default at 608, then process 600 can determine whether any inclusion filters include the order as to be exposed to the platform at 610. Any suitable inclusion filters can be used. For example, inclusion filters can be configured as described herein in connection with FIG. 3. If it is determined that no inclusion filters include the order for exposure to the platform at 610, then process 600, at 612, can clear the exposure status in the corresponding platform level row 106 for the order, such as is illustrated by the blank check boxes for exposure status indicators 136 of interface 100 of FIG. 1. Otherwise, if it is determined that an inclusion filter includes the order for exposure at 610, or if it is determined that the order is to be exposed by default at 608, then process 600 can determine whether any exclusion filters exclude the order from exposure to the platform at 614. If it is determined that the order is to be excluded from exposure to the platform at 614, then process 600 can branch to 612 to clear the exposure status in the corresponding platform level row 106 for the order. Otherwise, process 600 can branch to 616 to set the exposure status in the corresponding platform level row 106 for the order, such as is illustrated by the checks in the check boxes for exposure status indicators 136 of interface 100 of FIG. 1. Next, at 618, process 600 can receive any user override of the exposure status setting for the order/platform combination. This can be received in any suitable manner. For example, this can be received based on a trader manually setting or clearing a check in a check box of an exposure status indicator 136 of a user interface 100 as illustrated in FIG. 1. The setting and clearing of the exposure status indicators at 612 and 614 can be limited to happen when there has been no previous override of the exposure status setting by a trader in some embodiments.

Next, at 620, process 600 can determine if the platform-level row 106 (FIG. 1) for this order/platform combination excludes this order from exposure to the platform. If the order is determined to be excluded, then process 600 can branch to 622 to determine if there are any other platforms for this order and branch to 606 to select the next platform (if so) or to 604 to receive the next order (if not). Otherwise, process 600 can determine if there is any available size for this order/platform combination at 624. This determination can be made in any suitable manner. For example, process 600 can determine whether the amount displayed in field 138 of user interface 100 of FIG. 1 (for example), indicates that there is available size for the order/platform combination. If it is determined that there is no available size at 624, then process 600 can loop back to 622 and proceed as described above. Otherwise, process 600 can send/update the block order for the platform at 626. This sending/updating can be performed in any suitable manner. For example, this sending/updating can be performed by sending a message reflecting the available order size to the platform, by responding to a polling of the available order size by the platform, etc. Next, at 628, process 600 can determine if a match has been found for the order at the platform. This determination can be made in any suitable way. For example, this determination can be made by receiving a message from the platform that a match has been found. If it is determined that a match has not been found, then process 600 can branch to 622 and proceed as described above. Otherwise, at 630, process 600 can commit size corresponding to the match (which can be less than the amount exposed in some embodiments) to the platform (and update the committed amount shown in field 142 of FIG. 1) and open a negotiation window for a trade (for example, as illustrated in FIG. 5). The negotiation window can be operated in any suitable manner. For example, the negotiation window can be controlled by the platform selected at 606 or can be controlled by a platform other that the platform selected at 606 in some embodiments. After the traders conclude negotiation, at 632, any order size to be executed can be executed and any remaining size that was committed at 630 can be uncommitted, and then process 600 can loop back to 622 and proceed as described above.

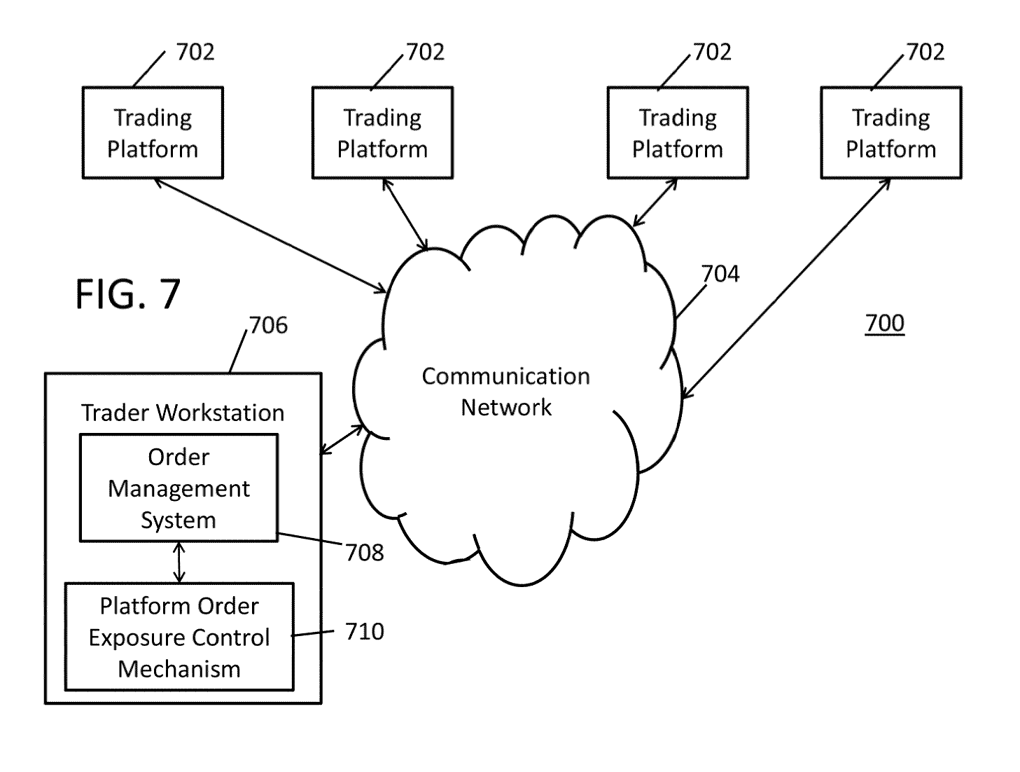

In accordance with some embodiments, a system 700 for controlling orders can be implemented as shown in FIG. 7. As illustrated, system 700 can include a plurality of trading platforms 702, a communication network 704, and one or more trader workstations 706.

Trading platforms 702 can be any suitable mechanisms for executing trades as known in the art, and can include, for example, crossing platforms, 101 (indications of interest) networks, execution management systems, etc. For example, a trading platform 702 implemented as a crossing platform can include the ConvergEx Cross crossing platform offered by BNY ConvergEx Group LLC of New York, N.Y. As another example, a trading platform 702 implemented as a crossing platform can include the Pipeline crossing platform offered by Pipeline Financial Group, Inc. of New York, N.Y. As yet another example, a trading platform 702 implemented as a crossing platform can include the Aqua crossing platform offered by Aqua Securities, LP of New York, N.Y.

Trading platforms 702 can include any suitable software, such as software for matching orders and executing trades and any suitable hardware, such as one or more general purpose devices such as a computer and/or one or more special purpose devices such as a client, a server, etc. Any of these general or special purpose devices can include any suitable components such as a hardware processor (which can be a microprocessor, digital signal processor, a controller, etc.), memory, computer networks, communication interfaces, display controllers, displays, input devices, etc.

Communication network 704 can be any suitable network (or combination of networks) for communicating information between the components of FIG. 7. For example, communication network 704 can include the Internet, an intranet, a wired network, a wireless network, a telephone network, a satellite network, a cable network, a local area network, a wide area network, a WiFi network, etc., and any suitable networking hardware (such as routers, switches, firewalls, etc.) and software.

A trader workstation 706 can be any suitable workstation for interfacing with a trader. For example, a trader workstation may be a desktop computer, a laptop computer, a dedicated terminal, a tablet computer, a personal digital assistant, a smart phone, etc. Any of these examples of trader workstations can include any suitable hardware, such as one or more general purpose devices such as a computer and/or one or more special purpose devices such as a client, a server, etc. Any of these general or special purpose devices can include any suitable components such as a hardware processor (which can be a microprocessor, digital signal processor, a controller, etc.), memory, computer networks, communication interfaces, display controllers, displays, input devices (such as a keyboard, touchpad, mouse, touch screen, pointing device, camera, microphone, etc.), etc.

As illustrated, in FIG. 7, workstation 706 can implement an order management system 708 in some embodiments. Order management system 708 can be any suitable order management system for managing orders, processing trades, etc. For example, an order management system 708 can include the Eze OMS from Eze Castle Software of BNY ConvergEx Group LLC of New York, N.Y. An order management system can include any suitable hardware, such as one or more servers or computers (which may include one or more hardware processors and memory), computer networks, displays, input devices, interfaces, etc., and any suitable software, such as software for managing orders and processing trades.

As also illustrated, in FIG. 7, workstation 706 can implement a platform order exposure control mechanism 710 in some embodiments. Platform order exposure control mechanism 710 can communicate with order management system 708 and trading platforms 702, and can implement the user interfaces and functionality described herein. Platform order exposure control mechanism 710 can include any suitable hardware, such as one or more servers or computers (which may include one or more hardware processors and memory), computer networks, displays, input devices, interfaces, etc., and any suitable software, such as software for managing orders and processing trades.

In some embodiments, any suitable computer readable media can be used for storing instructions for performing the functions described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A system for controlling the exposure of orders to trading platforms, comprising:
at least one hardware processor that:
receives information for at least one order to trade a security; and
for each of a plurality of trading platforms, determines how the at least one order is to be exposed to trading platform based on at least one of a default exposure setting for all orders for the trading platform, at least one filter for the trading platform, and an exposure status setting for the trading platform and the at least one order, and provides information for the at least one order to the trading platform.

2. The system of claim 1, wherein the information for the at least on order to trade a security is received from an order management system.

3. The system of claim 1, wherein the at least one filter for the trading platform includes an inclusion filter.

4. The system of claim 1, wherein the at least one filter for the trading platform includes an exclusion filter.

5. The system of claim 1, further comprising presenting a user interface that simultaneously indicates for the at least one order the exposure status setting for each of the plurality of trading platforms.

6. The system of claim 6, wherein the user interface also simultaneously indicates an amount exposed to each of the plurality of trading platforms for the at least one order.

7. The system of claim 1, wherein the plurality of trading platforms includes at least one crossing platform.

8. A method for controlling the exposure of orders to trading platforms, comprising:
receiving information for at least one order to trade a security; and
for each of a plurality of trading platforms, determining how the at least one order is to be exposed to trading platform based on at least one of a default exposure setting for all orders for the trading platform, at least one filter for the trading platform, and an exposure status setting for the trading platform and the at least one order, and providing information for the at least one order to the trading platform.

9. The method of claim 8, wherein the information for the at least on order to trade a security is received from an order management system.

10. The method of claim 8, wherein the at least one filter for the trading platform includes an inclusion filter.

11. The method of claim 8, wherein the at least one filter for the trading platform includes an exclusion filter.

12. The method of claim 8, further comprising presenting a user interface that simultaneously indicates for the at least one order the exposure status setting for each of the plurality of trading platforms.

13. The method of claim 12, wherein the user interface also simultaneously indicates an amount exposed to each of the plurality of trading platforms for the at least one order.

14. The method of claim 8, wherein the plurality of trading platforms includes at least one crossing platform.

15. A computer-readable medium containing computer-executable instructions that, when executed by a processor, cause the processor to perform a method for controlling the exposure of orders to trading platforms, the method comprising:
receiving information for at least one order to trade a security; and
for each of a plurality of trading platforms, determining how the at least one order is to be exposed to trading platform based on at least one of a default exposure setting for all orders for the trading platform, at least one filter for the trading platform, and an exposure status setting for the trading platform and the at least one order, and providing information for the at least one order to the trading platform.

16. The medium of claim 15, wherein the information for the at least on order to trade a security is received from an order management system.

17. The medium of claim 15, wherein the at least one filter for the trading platform includes an inclusion filter.

18. The medium of claim 15, wherein the at least one filter for the trading platform includes an exclusion filter.

19. The medium of claim 15, wherein the method further comprises presenting a user interface that simultaneously indicates for the at least one order the exposure status setting for each of the plurality of trading platforms.

20. The medium of claim 19, wherein the user interface also simultaneously indicates an amount exposed to each of the plurality of trading platforms for the at least one order.

21. The medium of claim 15, wherein the plurality of trading platforms includes at least one crossing platform.
